(19) United States
(12) Patent Application Publication
(10) Pub. No.: US 2025/0229541 A1
(43) Pub. Date: Jul. 17, 2025

(54) PRINTING SYSTEM, PRINTED OBJECT PRODUCTION METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Toshifumi SAKAI, Shiojiri (JP); Hiroyuki TOKUNAGA, Matsumoto (JP)

(21) Appl. No.: 19/017,873

(22) Filed: Jan. 13, 2025

(30) Foreign Application Priority Data
Jan. 15, 2024 (JP) 2024-003837

(51) Int. Cl. B41J 2/21; B41J 2/045; B41J 2/175; H04N 1/54

(52) U.S. Cl. CPC B41J 2/2103; B41J 2/04586; B41J 2/04588; B41J 2/17509; B41J 2/17543; H04N 1/54

(57) ABSTRACT

A printing system includes: a first ink receiving unit; a second ink receiving unit; a first identifier acquisition unit configured to acquire a first identifier indicating a type of a first ink set in the first ink receiving unit; a second identifier acquisition unit configured to acquire a second identifier indicating a type of a second ink set in the second ink receiving unit; a control data acquisition unit configured to acquire control data corresponding to a combination of the first identifier and the second identifier, from a database; an image data acquisition unit configured to acquire image data; and a printing unit configured to perform printing corresponding to the image data, using the first ink and the second ink, in accordance with the control data.

The present application is based on, and claims priority from JP Application Serial Number 2024-003837, filed Jan. 15, 2024, the disclosure of which is hereby incorporated by reference herein in its entirety.

### BACKGROUND

### 1. Technical Field

The present disclosure relates to a printing system, a printed object production method, and a non-transitory computer-readable storage medium storing a program.

### 2. Related Art

According to the related art, a printer that prints with inks of a plurality of colors is known. Also, when print data to be printed in the three colors of cyan, magenta, and yellow is outputted to a printer that prints in the four colors of cyan, magenta, yellow, and black, the printing cannot be performed correctly. To cope with such a problem, JP-A-2010-241066 discloses a technique of converting inputted print data to data corresponding to the type of an ink provided in a printing device.

JP-A-2010-241066 is an example of the related art.

According to the related art, since the type of the ink that can be used in one printing system is fixed, a printing system corresponding to the type of the ink needs to be manufactured.

### SUMMARY

According to an aspect of the present disclosure, a printing system includes: a first ink receiving unit; a second ink receiving unit; a first identifier acquisition unit configured to acquire a first identifier indicating a type of a first ink set in the first ink receiving unit; a second identifier acquisition unit configured to acquire a second identifier indicating a type of a second ink set in the second ink receiving unit; a control data acquisition unit configured to acquire control data corresponding to a combination of the first identifier and the second identifier, from a database; an image data acquisition unit configured to acquire image data; and a printing unit configured to perform printing corresponding to the image data, using the first ink and the second ink, in accordance with the control data.

According to another aspect of the present disclosure, a printed object production method includes: a first identifier acquisition step of acquiring a first identifier indicating a type of a first ink set in a first ink receiving unit; a second identifier acquisition step of acquiring a second identifier indicating a type of a second ink set in a second ink receiving unit; a control data acquisition step of acquiring control data corresponding to a combination of the first identifier and the second identifier, from a database; an image data acquisition step of acquiring image data; and a printing step of performing printing corresponding to the image data, using the first ink and the second ink, in accordance with the control data, and thus producing a printed object.

According to still another aspect of the present disclosure, a non-transitory computer-readable storage medium storing a program is provided, the program causing a computer to execute: a first identifier acquisition step of acquiring a first identifier indicating a type of a first ink set in a first ink receiving unit; a second identifier acquisition step of acquiring a second identifier indicating a type of a second ink set in a second ink receiving unit; a control data acquisition step of acquiring control data corresponding to a combination of the first identifier and the second identifier, from a database; an image data acquisition step of acquiring image data; and a print processing step of causing a printing unit to execute printing corresponding to the image data, using the first ink and the second ink, in accordance with the control data.

### BRIEF DESCRIPTION OF THE DRAWINGS

FIG. 1 is a schematic view of a printing system.

FIG. 2 shows the configuration of a printer.

FIG. 3 shows an example of a warning screen.

FIG. 4 is a flowchart showing printed object production processing.

### DESCRIPTION OF EMBODIMENTS

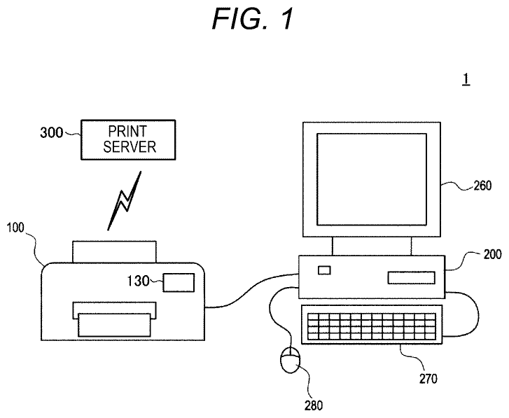

FIG. 1 is a schematic view of a printing system 1 according to an embodiment. The printing system 1 includes an inkjet-type printer 100, a computer 200, a display 260, a keyboard 270, and a print server 300. The printer 100 is an example of a printing device.

The printer 100 is connected to the print server 300 via a network. The print server 300 stores various information.

The printer 100 is coupled to the computer 200 via a USB cable. The printer 100 may also be coupled to the computer 200 via a communication cable conforming to another standard that enables transmission and reception data, and may also transmit and receive data to and from the computer 200 by wireless communication via a wireless LAN or the like. The printer 100 ejects an ink of one color or inks of a plurality of colors to a print medium such as a paper, based on print data generated by the computer 200, and thus can perform monochrome printing or color printing.

In the computer 200, a printer driver that controls operations of the printer 100 is installed, and the computer 200 generates print data to cause the printer 100 to print a print target such as a character or an image designated by the user.

The display 260 is coupled to the computer 200 and displays various information based on display data sent from a video driver (not illustrated) of the computer 200. For example, when the user selects a plurality of images to be candidates by operating the keyboard 270 or a mouse 280 in order to designate the print target, the display 260 displays these images. The display 260 may also display information such as print settings of the printer 100.

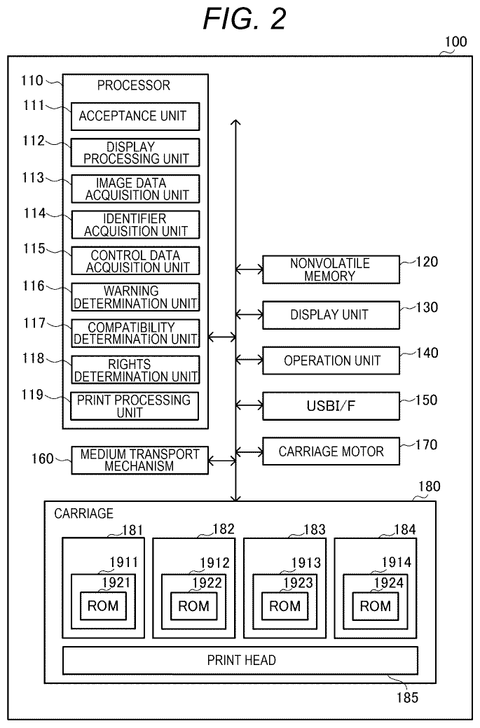

FIG. 2 shows the configuration of the printer 100. The printer 100 has a processor 110, a nonvolatile memory 120, a display unit 130, an operation unit 140, an interface (I/F) 150, a medium transport mechanism 160, a carriage motor 170, and a carriage 180. The carriage 180 is provided with a plurality of (in this example, four) cartridge holders 181, 182, 183, and 184.

In the four cartridge holders 181, 182, 183, and 184, four ink cartridges 1911, 1912, 1913, and 1914 containing an ink are set, respectively. The cartridge holders 181 to 184 are an example of an ink receiving unit. The number of the cartridge holders may be one or more.

The ink cartridges 1911, 1912, 1913, and 1914 include nonvolatile ROMs 1921, 1922, 1923, and 1924, respectively. The ROMs 1921 to 1924 are an example of an external recording medium. The ROMs 1921 to 1924 store an ink identifier to identify the type of the ink accommodated in the corresponding ink cartridge. The printer communicates with these ROMs and thus can read the ink identifier, remaining amount information or the like.

The carriage 180 also has a print head 185 provided with ink nozzles to eject the inks contained in the ink cartridges 1911 to 1914 to a print medium such as a paper. The print head 185 is an example of a printing mechanism.

For example, cyan (C), magenta (M), yellow (Y), and black (K) inks are contained in the ink cartridges 1911 to 1914, respectively. Thus, the printer 100 can support the four colors (CMYK). Also, the printer 100 according to this embodiment can print with other combinations of inks than this. For example, the ink cartridges 1911 to 1914 containing a black ink may be set in all the cartridge holders 181 to 184 and the printer 100 can thus perform printing in a single color. Also, inks of the three colors of CMKK may be contained in the ink cartridges 1911 to 1914 and the printer 100 can thus perform printing in three colors. The printer 100 can also print with RGB inks or with white, metallic, and clear inks or the like. Cartridges containing edible inks of the four colors of CMYK, respectively, may be set and the printer 100 can thus print on an edible sheet. In this way, in the printer 100 according to this embodiment, the type of the ink set in the ink cartridges 1911 to 1914 is not determined and various types of inks can be set. Such inks include a third-party ink. Thus, the printer 100 can perform printing in a plurality of different color spaces.

The I/F 150 may be a connector for wired connection or may be an antenna for wireless connection. The processor 110 has a CPU, a ROM, and a RAM, and executes a program recorded in the ROM or the nonvolatile memory 120 and thus can control each part of the printer 100. The processor 110 may be configured with a single chip or may be configured with a plurality of chips. Also, an ASIC may be employed instead of a CPU, and a configuration where a CPU and an ASIC cooperate with each other may be employed. In the nonvolatile memory 120, a program executed by the processor 110 and data or the like are recorded.

The processor 110 reads control data stored in the nonvolatile memory 120. The processor 110 controls operations of the medium transport mechanism 160, the carriage motor 170, and the print head 185, based on the control data, and image data transmitted from the computer 200, a scanner, a USB memory or the like via the I/F 150. The printer 100 causes the print head 185 to move forward and backward in a main scanning direction in relation to a print medium, along with the carriage 180 in response to the driving of the carriage motor 170. Meanwhile, the print medium is transported in a sub scanning direction by the medium transport mechanism 160. As an ink of one type or inks of a plurality of types are ejected to the print medium from the ink nozzles in the print head 185, an image that is a print target is printed. The medium transport mechanism 160, the carriage motor 170, and the carriage 180 form a printing unit.

The display unit 130 is provided at the casing of the printer 100 and displays various information. The operation unit 140 accepts a user operation. The operation unit 140 may be provided as unified with the display unit 130 in the form of a touch panel.

The printer 100 according to this embodiment can perform printing corresponding to the type of the ink contained in the ink cartridges 1911 to 1914 when the ink cartridges 1911 to 1914 are set, as described above. As a functional configuration to this end, the processor 110 has an acceptance unit 111, a display processing unit 112, an image data acquisition unit 113, an identifier acquisition unit 114, a control data acquisition unit 115, a warning determination unit 116, a compatibility determination unit 117, a rights determination unit 118, and a print processing unit 119.

The functions of the acceptance unit 111, the display processing unit 112, the image data acquisition unit 113, the identifier acquisition unit 114, the control data acquisition unit 115, the warning determination unit 116, the compatibility determination unit 117, the rights determination unit 118, and the print processing unit 119 are implemented by the processor 110 reading the program stored in the nonvolatile memory 120 and executing the program. That is, in the description below, the processing described as the processing executed by the acceptance unit 111, the display processing unit 112, the image data acquisition unit 113, the identifier acquisition unit 114, the control data acquisition unit 115, the warning determination unit 116, the compatibility determination unit 117, the rights determination unit 118, and the print processing unit 119 is the processing executed by the processor 110.

The acceptance unit 111 accepts an input of information in response to a user operation at the operation unit 140. The display processing unit 112 controls the display at the display unit 130. The image data acquisition unit 113 acquires image data from the computer 200 via the I/F 150. The identifier acquisition unit 114 acquires the ink identifier from the ROMs 1921 to 1924 of the ink cartridges 1911 to 1914. The control data acquisition unit 115 acquires control data for printing from the print server 300 or the ROMs 1921 to 1924 and stores the control data in a storage unit such as the nonvolatile memory 120.

The warning determination unit 116 determines whether a combination of inks (current inks) set in the printer 100 satisfies a warning condition, and gives a warning to the user when the combination satisfies the warning condition. As the warning condition, for example, a condition that a warning should be given when the cartridge is used simultaneously with a cartridge of which identification number, is stored in the ROM of the cartridge. The warning condition is set in such a way as to give a warning when a combination of inks that results in a narrower color gamut than a preset standard color range is set as a color gamut that can be printed, and not to give a warning when a combination of inks that is the same as the standard color gamut or that includes the standard color gamut is set. The standard color gamut is a color gamut that can be printed, based on a combination of inks preset as the inks set in the printer 100. For example, when a color range implemented by CMYK inks is set as the standard color gamut and only the K ink is set, the color range is narrowed. Therefore, in this case, the warning determination unit 116 determines that the warning condition is satisfied. In contrast, when a color gamut implemented by the K ink is set as the standard color gamut and the CMYK inks are set, the color gamut is broader than the standard color gamut. Therefore, the warning determination unit 116 determines that the warning condition is not satisfied.

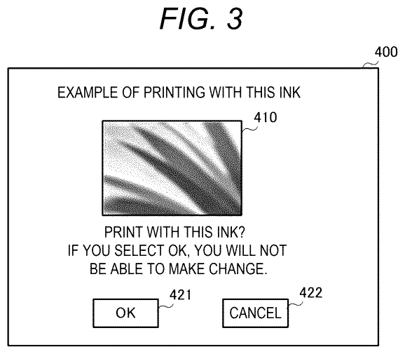

FIG. 3 shows an example of a warning screen 400 displayed at the display unit 130 by the display processing unit 112 as a warning to the user when the warning condition is satisfied. On the warning screen 400, an illustrative image 410 of an image assumed to be a print result with a plurality of current inks set at the time of processing (current time) is displayed. Also, an OK button 421 and a cancel button 422 are displayed. The user checks the illustrative image 410 and selects the OK button 421 when the illustrative image 410 is not different from a finished image expected by the user. In this case, the printing is performed with the combination of the current inks. The user selects the cancel button 422 when the illustrative image 410 is different from the expected finished image. In this case, the printing is cancelled.

The compatibility determination unit 117 determines whether the ink set and supplied in the past and the subsequently set ink satisfy a compatibility condition, when the ink cartridges 1911 to 1914 are replaced in the cartridge holders 181 to 184. The compatibility condition is a condition to determine that the past ink set in the past and the subsequently set current ink are compatible with each other. When the past ink and the current ink are the same color and therefore the same control data can be used, it is determined that the compatibility condition is satisfied. Meanwhile, when different control data need to be used, it is determined that the compatibility condition is not satisfied. Alternatively, when the past ink and the current ink are inks of types that cannot be mixed together, it is determined that the compatibility condition is not satisfied. For example, when the past ink is an inedible ink and the current ink is an edible ink, it is determined that the compatibility condition is not satisfied. The compatibility determination unit 117 determines the compatibility condition is satisfied, when the ink identifier of the past ink (past identifier) and the ink identifier of the current ink coincide with each other. Also, the compatibility determination unit 117 reads a compatibility condition saved in the ROM and determines whether the condition is satisfied. The ink identifier of the past ink is stored in the nonvolatile memory 120.

The rights determination unit 118 determines whether the user is a paying member who can use the inks set in the cartridge holders 181 to 184, when one of the inks or a combination of the inks is for paying members. That is, the rights determination unit 118 determines whether the user has rights to use the inks for paying members. Specifically, the print server 300 manages information about paying members, and the rights determination unit 118 makes an inquiry to the print server 300 and thus determines whether the user has the rights. The print processing unit 119 controls the printing unit to execute printing.

The print server 300 stores user identification information of a paying member having the rights, and the user identification information is suitably updated according to the acquisition or cancellation of the qualification as a paying member. The print server 300 also stores the ink identifier of an ink that requires rights. For example, when using an ink, a paying member makes payment corresponding to the printing of a printed object acquired using an ink acquired for free, instead of purchasing the ink. Alternatively, in order to print over a different color gamut from the standard color gamut, the user is required to pay an additional fee to become a paying member.

The print server 300 has a database storing control data of the printer 100 for each combination of inks. The control data is information used for control when the printer 100 performs printing. For example, color conversion data to convert the color space of image data from the RGB color space to the color space of the color of the ink set in the printer 100 is the control data. Also, waveform data to eject the ink set in the printer 100 is the control data. Also, data (lookup table or LUT) used for data conversion of image data such as color conversion or separation, and data such as the operation interval of cleaning, are the control data. Also, UI data displayed at the display unit 130 is included in the control data. The print server 300 may have all of these control data or may have only a part of these control data and may use data provided in advance in the printer 100, as the rest of the control data. The print server 300 also stores a member identifier of a paying member who can use a paid ink. The print server 300 is an example of an external server.

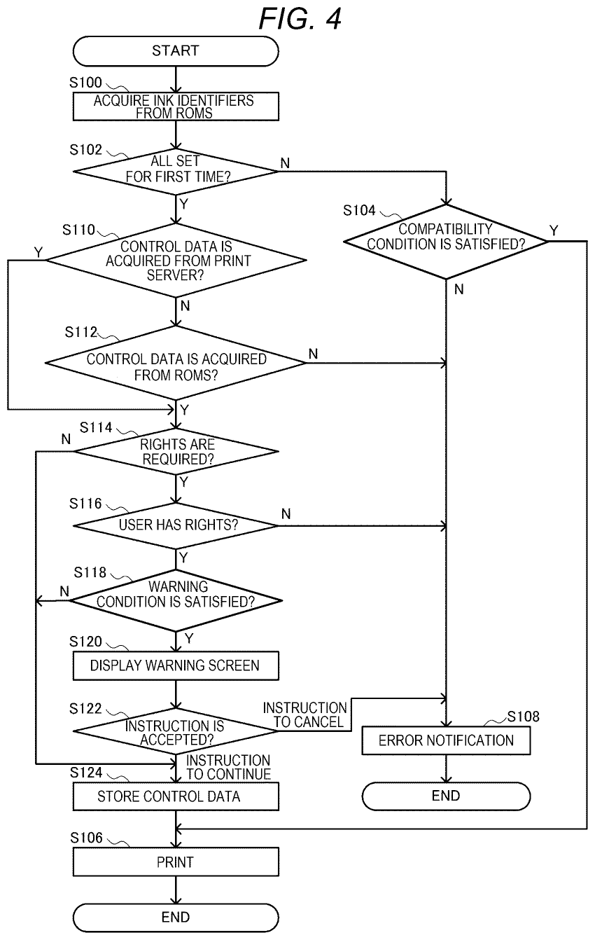

FIG. 4 is a flowchart showing the processing when the power is turned on by the processor 110 of the printer 100 or when an ink cartridge is newly set. In this flowchart, the identifier acquisition unit 114 of the processor 110 first acquires the ink identifiers stored in the ROMs 1921 to 1924 of all the ink cartridges 1911 to 1914 (step S100).

Next, the processor 110 checks whether the ink cartridges 1911 to 1914 set at the time of the processing (current time) are ink cartridges set in the cartridge holders 181 to 184 for the first time, based on the ink identifiers acquired from the ROMs 1921 to 1924. Since the ink identifiers of the ink cartridges set in the cartridge holders 181 to 184 in the past are stored in the storage unit such as the nonvolatile memory 120, the determination is made with reference to these ink identifiers.

When all the ink cartridges are set for the first time (Y in step S102), the processor 110 advances the processing to step S110. When not for the first time (N in step S102), the processor 110 advances the processing to step S104. In step S104, the processor 110 compares the ink identifier of the currently set ink cartridge with the ink identifier of the previously set ink cartridge (past identifier)) and thus determines whether the compatibility condition is satisfied.

When the compatibility condition is satisfied (Y in step S104), the print processing unit 119 configures settings to enable printing using the inks in the ink cartridges 1911 to 1914 set at the time of the processing (step S106). Although the control data is stored in the nonvolatile memory 120, the processor 110 may acquire new control data and use this control data. Thus, the printer 100 can use the latest control data. Specifically, the control data acquisition unit 115 acquires control data corresponding to the combination of the ink identifiers of the currently set inks from the print server 300 and newly stores this control data in the nonvolatile memory 120.

In another example, the processor 110 may determine whether to acquire new control data, according to an instruction from the user. In this case, when the control data acquisition unit 115 acquires new control data, the control data acquisition unit 115 stores this control data in the nonvolatile memory 120, whereas when the control data acquisition unit 115 does not acquire new control data, the control data acquisition unit 115 does not store anything in the nonvolatile memory 120. In this way, the printer 100 can determine whether to use new control data, according to the user's demand.

When the compatibility condition is satisfied, the ink set in the past and the currently set ink are of a combination of inks that can be mixed together without any problems. Therefore, when the compatibility condition is satisfied in this way, printing as usual is executed.

Meanwhile, when the compatibility condition is not satisfied (N in step S104), the processor 110 notifies the user of an error to the effect that the currently set ink cartridge cannot be used (step S108). Specifically, the display processing unit 112 displays an error screen to give an error notification at the display unit 130. When the compatibility condition is not satisfied, the ink set in the past and the currently set ink are of a combination of inks that cannot be mixed together. Therefore, in this case, the processor 110 gives an error notification without supplying the ink in the currently set ink cartridge and printing with this ink.

In step S110, the control data acquisition unit 115 of the processor 110 requests the print server 300 to provide control data corresponding to the combination of the ink identifiers of the currently set inks. In response to this request, the print server 300 transmits the control data corresponding to the combination of the ink identifiers. When the control data is transmitted to the control data acquisition unit 115 from the print server 300 and the control data acquisition unit 115 acquires the control data (Y in step S110), the control data acquisition unit 115 stores the control data in the nonvolatile memory 120 and advances the processing to step S114. When the control data acquisition unit 115 cannot acquire the control data (N in step S110), the control data acquisition unit 115 advances the processing to step S112. When the control data cannot be acquired refers to when the control data corresponding to the combination of the target inks is not stored in the print server 300. For example, when the combination of the target inks includes a third-party ink, it can be the case that the control data is not stored in the print server 300.

In step S112, the control data acquisition unit 115 of the processor 110 acquires control data from the ROMs 1921 to 1924 of the ink cartridges 1911 to 1914. When the control data is acquired (Y in step S112), the processor 110 stores the control data in the nonvolatile memory 120 and advances the processing to step S114. When the control data cannot be acquired (N in step S112), the processor 110 advances the processing to step S108. That is, in this case, the processor 110 gives an error notification and ends the processing without printing. When the control data cannot be acquired refers to when the control data corresponding to the combination of the target inks is not stored in any one of the ROMs 1921 to 1924.

In step S114, the rights determination unit 118 of the processor 110 makes an inquiry to the print server 300 and thus checks whether rights are required for the combination of the currently set inks. When rights are required (Y in step S114), the rights determination unit 118 advances the processing to step S116. When rights are not required (N in step S114), the rights determination unit 118 advances the processing to step S124.

In step S116, the rights determination unit 118 checks whether the user has the rights. Specifically, the rights determination unit 118 transmits user identification information inputted by the user to the print server 300. The print server 300 determines that the user has the rights, when the user identification information registered as a paying member and the user identification information received from the printer 100 coincide with each other, whereas the print server 300 determines that the user does not have the rights, when these pieces of user identification information do not coincide with each other. Then, the print server 300 notifies the printer 100 of the result of the determination. When the rights determination unit 118 receives a notification that the user has the rights (Y in step S116), the rights determination unit 118 advances the processing to step S118. When the rights determination unit 118 receives a notification that the user does not have the rights (N in step S116), the rights determination unit 118 advances the processing to step S108. That is, when the user does not have the rights, an error notification is given and the processing ends without printing.

In step S118, the warning determination unit 116 determines whether the combination of the current inks satisfies the warning condition. When the combination of the current inks does not satisfy the warning condition (N in step S118), the warning determination unit 116 advances the processing to step S124. When the combination of the current inks satisfies the warning condition (Y in step S118), the warning determination unit 116 advances the processing to step S120.

In step S120, the display processing unit 112 displays the warning screen 400 at the display unit 130. Next, the acceptance unit 111 accepts an instruction to continue or an instruction to cancel. When the OK button 421 is selected on the warning screen 400, the acceptance unit 111 accepts the instruction to continue, whereas when the cancel button 422 is selected, the acceptance unit 111 accepts the instruction to cancel. When the instruction to continue is accepted (instruction to continue in step S122), the processor 110 advances the processing to step S124. When the instruction to cancel is accepted (instruction to cancel in step S122), the processor 110 advances the processing to step S108. That is, in this case, the processor 110 gives an error notification and ends the processing without printing.

In step S124, the control data acquisition unit 115 stores the control data corresponding to the combination of the ink identifiers of the corresponding current inks, in the nonvolatile memory 120. Next, in step S106, the print processing unit 119 configures settings to enable printing using the inks in the ink cartridges 1911 to 1914 set at the time of the processing. Thus, a printer corresponding to a combination of ink cartridges is produced. Subsequently, upon receiving an instruction to print from the user, the printer prints image data. Specifically, the medium transport mechanism 160, the carriage motor 170, and the carriage 180 are controlled, thus performing printing using the inks in the ink cartridges 1911 to 1914 set in the cartridge holders 181 to 184. Thus, a printed object using the combination of the set ink cartridges is produced. In the printing, the control data stored in the nonvolatile memory 120 is referred to and the image data acquired by the image data acquisition unit 113 is used.

As described above, in the printing system 1 according to the embodiment, since control data is acquired according to the combination of the current inks, printing corresponding to the combination of the current inks can be performed. Thus, a common printer model may be manufactured instead of manufacturing different printer models from one combination of inks to another, and therefore the manufacturing cost can be reduced. Also, in the printing system 1, when the combination of the current inks satisfies the warning condition, a warning can be given to the user. Therefore, upon receiving the warning, the user can check whether the printing with the current inks has no problem, before the printing.

Also, the printing system 1 performs printing in the case where the supply of an ink was not performed in the past, whereas the printing system 1 limits printing according to the ink used in the past in the case where the supply of the ink was performed in the past. Specifically, the printing system 1 performs printing when the combination of the past ink and the current ink satisfies the compatibility condition, whereas the printing system 1 does not supply any ink when the combination does not satisfy the compatibility condition. Therefore, inks that cannot be mixed together can be prevented from being mixed together. Also, the printing system 1 checks the user's rights before printing. Therefore, the printing system 1 can manage printing so as not to perform printing by a user having no rights.

The foregoing embodiment is an example to carry out the present disclosure and various other embodiments can be employed.

As such an embodiment, in a first modification example, an ink tank, instead of an ink cartridge, may be set in the printer 100. In this case, ink is poured into the ink tank from an ink bottle. Also, in this case, the printer 100 has a reading unit, not illustrated, and the reading unit reads an ink identifier via a barcode or a two-dimensional code printed on the label on the ink bottle or the exterior of the package box thereof. Then, the identifier acquisition unit 114 acquires the ink identifier read by the reading unit. In this way, the mechanism to acquire the identifier is not limited to that of the embodiment. Also, the present disclosure may be applied to a laser printer that prints using a toner ink.

In a second modification example, the print server 300 may store a plurality of control data corresponding to the same combination of ink identifiers. Also, in this case, the display processing unit 112 displays the plurality of control data, and when desired control data is selected by the user, the acceptance unit 111 accepts the designation of the control data selected by the user. Then, the control data acquisition unit 115 acquires the control data selected by the user. Thus, when a plurality of control data are prepared, the user can perform printing with desired control data.

In a third modification example, the rights determination unit 118 may periodically determine whether the user has the rights, regardless of the timing of printing. Thus, even with respect to a user who is determined as having the rights once but who subsequently no longer has the rights, the processor 110 can determine whether the user has the rights correctly. Specifically, even with respect to a user who is determined as having the rights once, the processor 110 performs control not to perform printing when the user subsequently loses the rights. Thus, proper printing corresponding to the user's rights can be managed.

In a fourth modification example, the warning determination unit 116 may present a sample of the result of printing, as a warning to the user. For example, a sample based on preset print settings, such as paper selection of normal paper, photographic paper or the like, and paper size, may be presented. Also, in this case, the print settings may be initial settings or may be favorite settings set by the user.

In a fifth modification example, the warning condition may be a condition to give a warning when the result of printing intended by the user may not be able to be acquired, and the content of the condition is not limited to that of the embodiment. The warning condition may be, for example, that the combination of inks is a combination other than the preset combination of inks in the printer 100. Even a combination of inks for which different control data are used may be regarded as satisfying the compatibility condition. In this case, the processing advances from step S104 to step S110. Also, the determination about the compatibility condition, the determination about the rights, and the determination about the warning condition may be not performed.

The above embodiments are examples to carry out the present disclosure, and various other embodiments can be employed. Various modifications and changes can be made within the scope of the present disclosure described in the accompanying claims, such as applying a modification example of one embodiment to another embodiment.

The present disclosure is also applicable as a program or a method executed by a computer. The present disclosure may be implemented as a single device, as described above, or may be implemented using components of a plurality of devices, and therefore includes various aspects. Also, suitable changes can be made, such as a part being software and a part being hardware. Moreover, the present disclosure can be applied as a recording medium of a program that controls the system. Of course, the recording medium of the program may be a magnetic recording medium or a semiconductor memory, and any recording medium to be developed in the future can be similarly considered. The present disclosure may also be applied as a printer driver or an application that executes a part or all of the processing in the foregoing flowchart.

What is claimed is:

1. A printing system comprising:
a first ink receiving unit;
a second ink receiving unit;
a first identifier acquisition unit configured to acquire a first identifier indicating a type of a first ink set in the first ink receiving unit;
a second identifier acquisition unit configured to acquire a second identifier indicating a type of a second ink set in the second ink receiving unit;
a control data acquisition unit configured to request a database to provide control data corresponding to a combination of the first identifier and the second identifier;
a storage unit storing the control data acquired from the database in response to the request;
an image data acquisition unit configured to acquire image data; and
a printing unit configured to perform printing corresponding to the image data, using the first ink and the second ink, in accordance with the control data.

2. The printing system according to claim 1, wherein
the first ink receiving unit fixes a first ink cartridge containing the first ink,
the second ink receiving unit fixes a second ink cartridge containing the second ink,
the first identifier acquisition unit acquires the first identifier from the first ink cartridge, and
the second identifier acquisition unit acquires the second identifier from the second ink cartridge.

3. The printing system according to claim 1, wherein
the first ink receiving unit is a first ink tank in which the first ink is poured from a first ink bottle,
the second ink receiving unit is a second ink tank in which the second ink is poured from a second ink bottle,
the first identifier acquisition unit acquires the first identifier read from an exterior of the first ink bottle by a first reading unit, and
the second identifier acquisition unit acquires the second identifier read from an exterior of the second ink bottle by a second reading unit.

4. The printing system according to claim 1, wherein
the control data includes color conversion data to convert a color space of the image data from an RGB color space to a color space including a color of the first ink and a color of the second ink.

5. The printing system according to claim 1, wherein
the control data includes waveform data to eject the first ink and the second ink.

6. The printing system according to claim 1, wherein
the control data acquisition unit acquires the control data that is one of a plurality of the control data according to the combination of the first identifier and the second identifier.

7. The printing system according to claim 6, wherein
the control data acquisition unit acquires the control data that is one of a plurality of the control data according to a selection by a user.

8. The printing system according to claim 1, wherein
the control data acquisition unit acquires the control data from an external recording medium.

9. The printing system according to claim 8, wherein
the control data acquisition unit acquires the control data from the external recording medium when the control data cannot be acquired from the database.

10. A printed object production method comprising:
a first identifier acquisition step of acquiring a first identifier indicating a type of a first ink set in a first ink receiving unit;
a second identifier acquisition step of acquiring a second identifier indicating a type of a second ink set in a second ink receiving unit;
a control data acquisition step of acquiring control data corresponding to a combination of the first identifier and the second identifier, from a database; and
a printing step of causing a printing mechanism to perform printing corresponding to image data, using the first ink and the second ink, in accordance with the control data, and thus producing a printed object.

11. A non-transitory computer-readable storage medium storing a program, the program causing a computer to execute:
a first identifier acquisition step of acquiring a first identifier indicating a type of a first ink set in a first ink receiving unit;
a second identifier acquisition step of acquiring a second identifier indicating a type of a second ink set in a second ink receiving unit;
a control data acquisition step of acquiring control data corresponding to a combination of the first identifier and the second identifier, from a database; and
a print processing step of causing a printing mechanism to execute printing corresponding to image data, using the first ink and the second ink, in accordance with the control data.
